(19) United States
(12) Patent Application Publication
(10) Pub. No.: US 2010/0309179 A1
(43) Pub. Date: Dec. 9, 2010

(54) Device for Controlling Pixels and Electronic Display Unit

(75) Inventor: Robert Missbach, Kreischa/OT Barenklause (DE)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SeeReal Technologies S.A., Munsbach (LU)

(21) Appl. No.: 12/863,856

(22) PCT Filed: Jan. 21, 2009
(86) PCT No.: PCT/EP2009/050615

§ 371 Date: Jul. 21, 2010

(30) Foreign Application Priority Data
Jan. 21, 2008 (DE) 10 2008 000 110.4
Mar. 19, 2008 (EP) 08102762.5

(51) Int. Cl. G09G 5/00

(52) U.S. Cl. 345/205

(57) ABSTRACT

In a pixel matrix subdivided into clusters, the clusters are connected to a control circuit outside the pixel matrix by way of a point-to-point connection. Each cluster is an active matrix structure made of row and column lines and pixel TFTs. Chains of analog and digital shift registers are provided for the local row and column lines. Further, clusters can be used that have a hierarchical set-up in which N local shift registers branch off of global shift registers. Data values are conveyed within the local shift register at a lower cycle time than the global shift register until the data values arrive at the outputs of the shift register for controlling the pixels. This control mechanism can be integrated into the pixel matrix of a display and avoids non-transparent areas.

The invention relates to a device for controlling pixels of a pixel matrix and to an electronic display device which comprises this pixel matrix.

The electronic display device is in particular designed in the form of a high-resolution display which is used for displaying information.

The field of application of the invention includes high-resolution displays, in particular TFT (thin film transistor) displays which are used for purposes where the pixels are required to be controlled very quickly and which comprise spatial light modulators in a pixel matrix. Another field of application are optical elements with a pixel matrix, said elements affecting the direction or shape of a beam or the shape of a coherent wave front.

In prior art TFT displays the pixels are normally controlled using a grid of row and column lines, where the pixel TFTs are located at the intersecting points of those lines. This design is known as an active matrix (AM). In these displays, one pixel row is always activated by a row line (or gate line), and analogue values are simultaneously written to all pixels of the activated row through the column lines (or data lines).

However, this type of addressing using global row and column lines as used in conventional display devices proves to be inadequate in conjunction with increasing resolutions and refresh rates as they are required for example for the representation of holograms in holographic displays. Increasing the frequency on the column lines means that the capacitance of the column lines and pixel TFTs must be subjected to charge reversals in much shorter intervals.

As a consequence, the power loss increases as the frequency rises. There is a limit defined by the impedance and capacitance of the conductor beyond which it is no longer possible to achieve a full charge reversal in the conductor in one clock cycle.

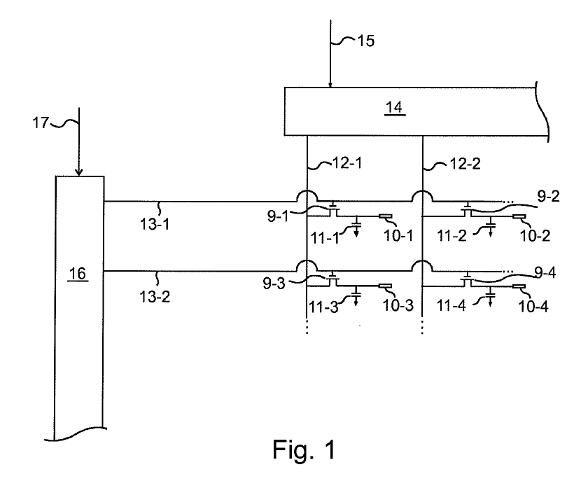

This is illustrated with the following example. Common TFT displays, which exhibit resolutions of up to 3840×2400 pixels today, can be controlled according to the aforementioned general principle with column and row drivers, as is shown schematically in FIG. 1. FIG. 1 shows four pixel electrodes 10-1, 10-2, 10-3, 10-4, which have corresponding pixel capacitances 11-1, 11-2, 11-3, 11-4, and which are controlled through the column lines 12-1, 12-2 and row lines 13-1, 13-2.

The column lines are addressed by a driver circuit 14, which is arranged outside of the pixel matrix, and which has at least one corresponding multiplexed analogue input 15. The row lines are switched by a digital shift register 16, which is controlled by a token bit for row control through the input 17. Both circuits are disposed along the edge of the TFT panel.

Such a control arrangement will cause substantial problems in holographic displays, which require very high resolutions of more than 100m pixels in conjunction with refresh rates of more than 100 Hz. If the number of rows or the refresh rate of a TFT display is increased, the control frequency on the row and column lines will rise as follows:

Control frequency=Refresh rate*Number of rows

While this frequency is about 72 kHz in today's panels (assuming 1200 rows and a refresh rate of 60 Hz), it could easily rise to 720 kHz in panels with 4000 rows and a refresh rate of 180 Hz).

The drawbacks in this respect become more grave as the display size rises, because accordingly longer conductors must be situated and used. For example, if a 40-inch display panel is divided into quarters in order to minimise the length of the conductors, the length of the row lines is about 400 mm. A further reduction in conductor length is not possible as long as control lines are used which are addressed by drivers which sit outside the pixel matrix.

If this quarter has 4000 rows and if the panel is operated at a refresh rate of 180 Hz, these values can hardly be realised efficiently with the conventional arrangement of row and column lines as shown in FIG. 1 due to the length of the conductors.

The problem of prior art devices is therefore the fact that the control of the pixels which is typically employed in TFT displays cannot be achieved within a period of the control frequency which results from the required number of rows and refresh rate.

Because of the required fast charge reversal, the power loss rises to the same degree, which leads to an increased power consumption and generation of excess heat. The latter must additionally be dissipated.

These problems become even more grave in a high-resolution display, which is to be used for generating holographic reconstructions and which has a very high number of pixels, e.g. 16000×8000 pixels, and a refresh rate of 150 Hz. Due to the extremely high switching frequencies, display panels with conventional pixel control cannot be employed as holographic displays.

The hitherto unpublished patent application DE 10 2007 040712 filed by the applicant discloses a way of simplifying the pixel control by dividing the display panel into a multitude of clusters and controlling the clusters with waveguides. A cluster shall be understood to be a partial display with a given number of pixels which belong together by the organisation of the control. A multitude of clusters forms the display panel.

Each waveguide connects an output of the data driver circuit and the assigned input of the receiver circuit of a cluster. The information is transmitted through terminated waveguides without any signal reflection, so that high data rates can be achieved.

However, this control arrangement has the disadvantage that each cluster must be provided with a relatively complex receiver circuit. This is difficult to be realised in practice without impairing the function of the panel because of the little space that is available between the large number of pixels.

It is thus the object of the present invention to improve the pixel control and to realise both a high resolution and a high refresh rate in an electronic display device by way of dividing a pixel matrix into clusters.

This object is solved according to this invention by a device according to claim 1, an electronic display device according to claim 15, and an optical element according to claim 16.

The device for controlling the pixels of a pixel matrix according to this invention comprises
A pixel matrix which is divided into a multitude of clusters,
At least one data driver circuit with at least one output for outputting control information per cluster, and
Global shift registers which are assigned to one or multiple clusters, said shift registers having an input for receiving the control information from the data driver circuit and for passing the received control information on to one or multiple clusters, where the global shift registers are disposed across the entire area of the pixel matrix between the pixels.

The electronic display device according to this invention comprises a matrix of light modulators as a pixel matrix (e.g. a liquid crystal (LC) matrix, OLED matrix, magneto-optic (MO) matrix or matrix of electrowetting cells) according to at least one of claims 1 to 13.

According to at least one of claims 1 to 13, an optical element according to this invention comprises a pixel matrix which forms an array of beam-deflecting and/or beam-shaping pixels.

According to one aspect of the invention, each cluster has a local digital and a local analogue shift register, and the control information is further distributed within the cluster with the help of an active matrix structure.

According to another aspect of the invention, the shift registers have a hierarchical multi-stage structure.

Preferred embodiments of the invention are defined in the dependent claims.

A pixel matrix shall be understood to be an array of light-affecting cells which are arranged in rows and columns. The cells can affect one or multiple properties of light in the visible or non-visible spectral range.

In the context of this invention, a pixel matrix can be a part of a display device, a wave front forming device, an optical imaging device, or an optical deflection unit.

If used as light modulator, it affects the intensity, phase, polarisation, wavelength or more than one of these properties at the same time.

If used as phase arrays, it can serve for wave front forming. If used as variable prism arrays, it affects the direction of light beams in one or two dimensions. If used as variable lens arrays, it affects the shape of light beams. Lens array and prism array function can also be combined in one pixel matrix. A pixel matrix can be of a reflective or transmissive type, or emit light actively (e.g. an OLED matrix). Multiple prism matrices can be disposed one after another in order to affect multiple properties of the light independent of one another.

As the clock pulses which are used in the shift registers in this implementation have the highest frequency and require additional lines, these clock pulses are generated according to one option at different positions in the display panel, e.g. once per cluster, or at any point where the clock pulse is required with the help of a photosensitive receiver from an optical signal. A photosensitive TFT can for example serve as receiver. The signal can be modulated into the light sources which are used for back-lighting the pixel matrix. Alternatively, a second light source could be used which emits light of a wavelength outside the visible range.

The invention is described in more detail below with the help of the accompanying drawings wherein:

FIG. 1 shows a detail of a circuit diagram of the control circuitry for controlling pixels of a pixel matrix according to the prior art,

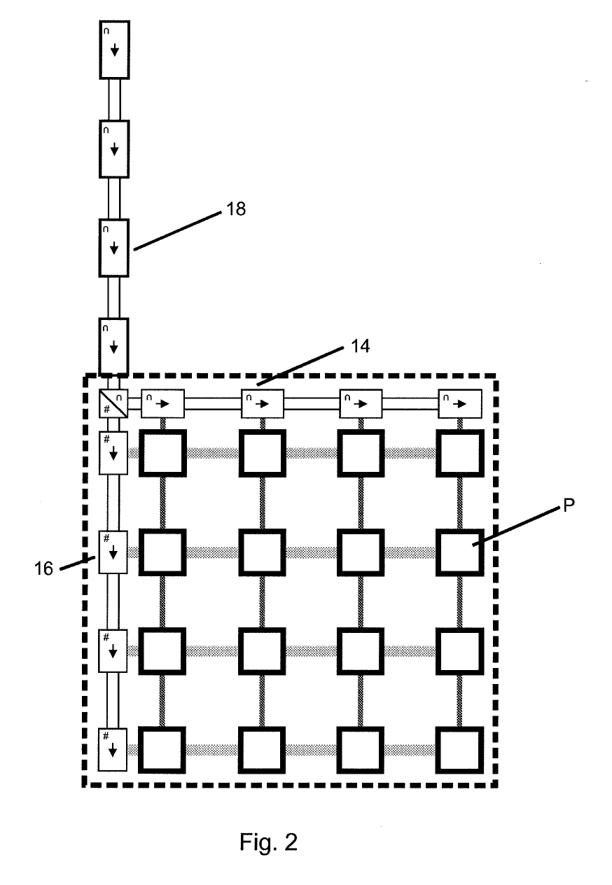

FIG. 2 is a simplified schematic diagram which shows a cluster control according to this invention,

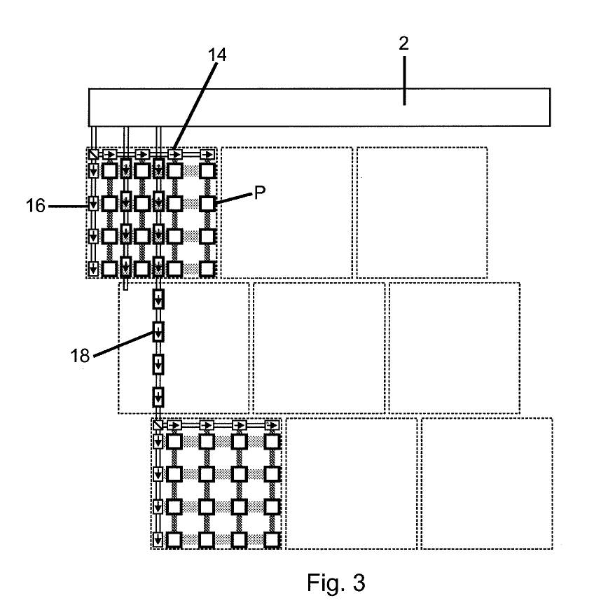

FIG. 3 is a simplified schematic diagram which shows a pixel matrix with the cluster control according to one embodiment of this invention,

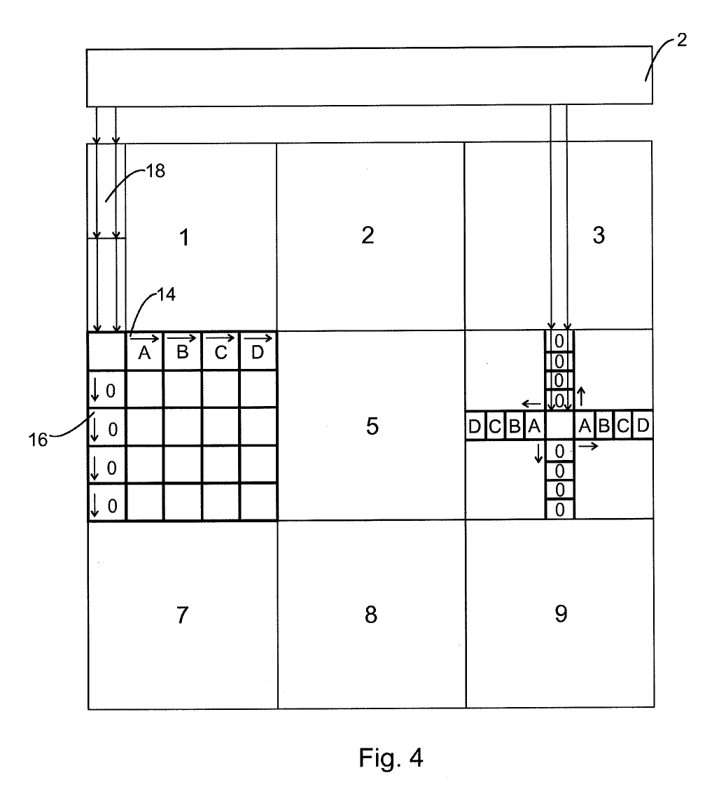

FIG. 4 is a simplified schematic diagram which shows two possibilities for the arrangement of the analogue and digital shift register which are controlled in a cluster,

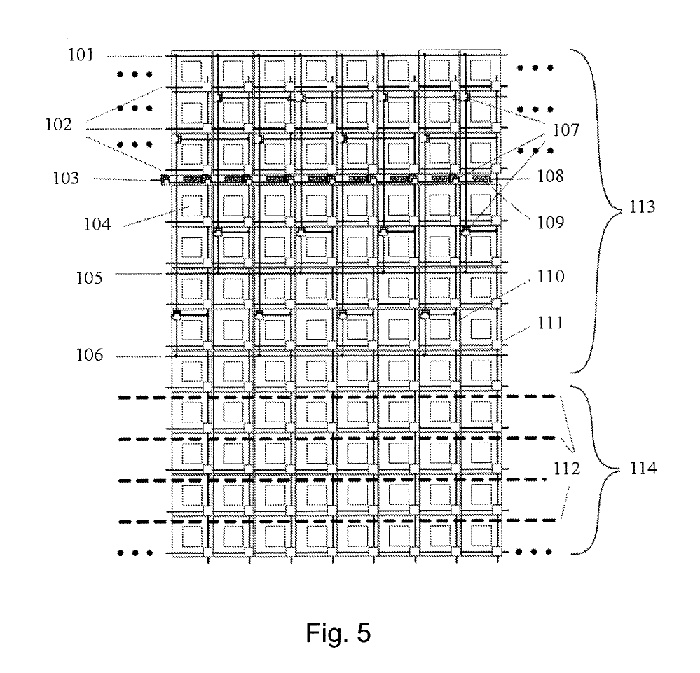

FIG. 5 is a schematic diagram which illustrates the embedding of the shift registers between the pixels of the local active matrix, and

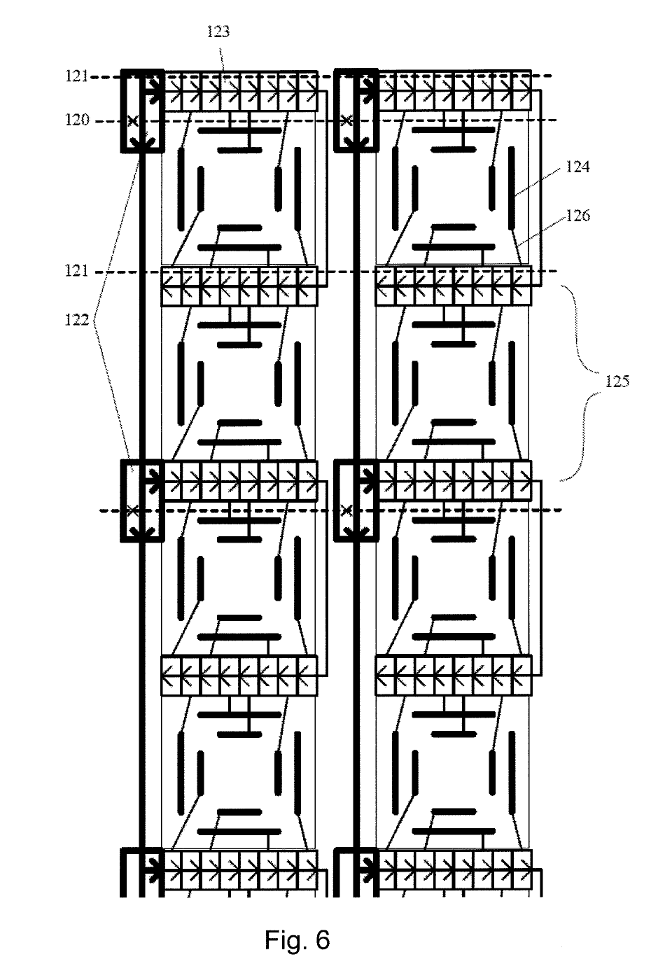

FIG. 6 is a schematic diagram which shows the hierarchical structure of shift registers for an exemplary pixel matrix with electrowetting cells.

FIG. 1 has been described in the prior art section. The pixels, which are shown schematically in this figure, and which comprise the pixel electrodes 10-1 to 10-4, capacitors 11-1 to 11-4 and pixel TFTs 9-1 to 9-4, are arranged side by side in rows and below one another in columns with the necessary gaps in between for the control lines, and form a cluster together with a control through local analogue and digital shift registers.

According to this invention, a thus structured cluster is assigned with another shift register, which is called a global shift register 18. FIG. 2 shows schematically a cluster with these three shift registers. To keep things simple, the local analogue shift register 14 and the local digital shift register 16 of a cluster will be referred to as analogue and digital shift registers 14 and 16. Voltage values for the pixels P are written to the analogue shift register 14 through the column lines 12, while the digital shift register 16 is used for activating the pixel transistors of a pixel row through the row lines 13. A global shift register 18 can also be used for providing control information to multiple clusters.

The pixels P, which are connected by row and column lines and which are shown as square elements, comprise at least one control transistor per pixel P. The provision of information through the row and column lines is defined as an active-matrix structure. A broken line box around the pixel matrix and shift register outlines a cluster.

A multitude of these clusters are disposed side by side and one below another, thus forming a pixel matrix according to a first embodiment according to this invention, which can be realised for example in a display device.

The global shift registers 18 of the clusters are connected with data driver circuits (not shown) to receive the control information. The function of a global shift register 18 will be explained in more detail in the embodiments described below.

Referring to FIG. 3, the clusters can also be arranged at a certain offset between adjacent rows. This has the advantage that not all the global shift registers 18 which run from the data driver circuits 2 to the clusters in the display device are routed in one column, as would be the case in display devices with e.g. only clusters 4 or clusters 6 according to FIG. 4, but are distributed over a larger area.

This further way of organising clusters and the distribution of information within a cluster can also include a hierarchical structure of shift registers according to a second embodiment.

FIG. 4 shows possible arrangements of the analogue and digital shift registers which are provided in a pixel matrix e.g. in a display device. The pixel matrix comprises e.g. nine clusters. Two shift register arrangements are shown in detail in clusters 4 and 6.

Cluster 4 has an analogue and a digital shift register 14 and 16 for providing the control information, which are disposed at the edge of the cluster, as in the prior art. The local row and column lines which connect the individual pixels P in cluster 4 are also shown in the drawing.

One embodiment of a display device would for example comprise nine of those clusters 4. The information being fed into the two shift registers 14, 16 of the respective cluster is provided by a global shift register 18 at each point where the two local shift registers are intersecting.

The shift registers 14, 16 are provided with control information serially by the shift register 18. According to this invention, each cluster 1 to 9 has at least one global shift register 18 (only shown for clusters 4 and 6 in the drawing). In cluster 4 the receiver unit of the analogue shift register receives the control information and passes it on to the individual pixels P of cluster 4 through the local row and column lines.

In both possible embodiments of pixel matrices, at least one data driver circuit 2 which is disposed outside of the display panel supplies the input information for the global shift register 18 which is assigned to at least one cluster and which shifts the control information.

FIG. 5 shows the embedding of the shift registers between the pixels of the local active matrix (AM). The chosen example shows a detail of a cluster with a digital shift register with two different clock cycles, which comprises three transistors and one capacitor per stage. Unlike in FIGS. 1 to 4, the digital shift register is not disposed in the vertical direction but in the horizontal direction in this example; both options are possible as they have the same function, but are turned by 90°.

Although about 3 to 5 transistors (TFTs) are needed per segment to realise the digital shift registers, and about 7 to 12 transistors to realise the analogue shift registers, already at a cluster size of 64×64 pixels only about 30% more TFTs are needed altogether in addition to the pixel TFTs to implement the shift registers.

If the clusters are realised with the more sensible size of 256×256 pixels, the amount of additional TFTs is only 10%.

It is thus possible to realise a display which has 1.1 TFTs per pixel on average, which is only insignificantly more than a conventional display which has one TFT per pixel.

However, it is essentially to distribute these additional TFTs over an expanded area, as shown in FIG. 6, so that these elements are not concentrated in one area, thus forming non-transparent areas.

In FIG. 5 the reference numerals denote the following elements:
101 a conductor for power supply,
102 the local row lines of the AM in the cluster, fed by the analogue shift register (not shown in the drawing),
103 the input of a stage of the digital shift register which is fed by the output of the previous stage,
104 a transparent area of the pixel,
105 a conductor for the 1^{st} clock cycle,
106 a conductor for the 2^{nd} clock cycle,
107 three TFTs of a stage of the digital shift register,
108 the output of the digital shift register,
109 a capacitor of the digital shift register,
110 the column line of the AM which is controlled by the outputs of the digital shift register,
111 an active-matrix TFT,
112 data lines for other clusters,
113 an area of the local cluster in which the TFTs and the conductor connections of the digital shift register are embedded, and
114 an area of the local cluster in which no TFTs of the digital shift register are embedded, and which is thus available for the implementation of global connections and shift registers.

FIG. 6 shows the realisation with hierarchical shift registers for an example of a pixel matrix with electrowetting cells with 8 electrodes per pixel. The drawing shows a detail of a cluster. It shows 8 pixels in 2 columns and 4 rows. The shift register of the 2^{nd} stage with 16 shift cells to be controlled outputs its values to two pixels with 8 electrodes each. The number of shift cells and thus the number of controlled pixels is likely to be higher in a concrete application than in this example.

In FIG. 6 the reference numerals denote the following elements:
120 the clock cycle of the 1^{st} stage,
121 the clock cycle of the 2^{nd} stage,
122 an analogue shift register of the 1^{st} stage,
123 an analogue shift register of the 2^{nd} stage,
124 the electrodes of the electrowetting cells,
125 a pixel which comprises of an electrowetting cell with 8 electrodes, and
126 the connection of the output of the shift register of the 2^{nd} stage to the electrode.

The analogue shift registers can for example comprise amplifiers with the amplification 1 and transfer transistors or CCD structures.

CCDs (charge-coupled devices) are a special type of analogue shift registers. They have a simple structure with two continuous semiconductor layers and electrodes which are mounted on them. A structure which resembles that of CCD camera sensors can be used to implement the shift registers in the realisation suggested here. In contrast to camera sensors, the charges are transported into the substrate and not out of the substrate. Here, the columns could be used for CCD chains and the rows could be used for the clock lines.

The main problem with CCDs, but also with other implementations of analogue shift registers, are inhomogeneities of the TFT substrate, as for example in poly-silicon. A small portion of the charge is lost during each transfer or is added to the next value. This effect is described by the charge transfer efficiency (CTE). Normally, the CTE must be very high (99.9999%) to be able to realise multiple serially connected shift cells of the shift registers and thus multiple pixels which are connected to the outputs.

An error of about 0.5% is acceptable to achieve an accuracy of 8 bit. If 32,000 pixels were connected to the outputs of the shift cells of a shift register, the CTE had to be 99.999984% (100%-(0.5%/32000)) for 32,000 transfers.

The CTE depends mainly on the quality of the TFT substrate used. The quality of p-Si substrate is very low compared with that of mono-crystalline silicon.

Because of the problems with the inhomogeneities of p-Si substrates, a control with simple, single-stage analogue shift registers with about 32,000 transfers is impossible or at least very difficult to be realised.

If the shift registers are arranged in a hierarchical structure such that for example the shift register of the 1^{st} stage has 128 shift cells from each of which 128 further shift registers of the 2^{nd} stage branch off with again 256 shift cells each, this will make it possible to control 32,768 pixels after maximal 384 transfers. This is illustrated in FIG. 6 with the help of a detail that shows 2 shift cells of the shift register of the 1^{st} stage and 16 shift cells of the shift register of the 2^{nd} stage.

It takes 128 clock cycles to write 128 different values to the shift cells of the analogue shift register of the 1^{st} stage. Each output of a member of the 1^{st} stage is connected with an input of an analogue shift register of the 2^{nd} stage. Now, a 128 times slower clock pulse of the 2^{nd} stage triggers the transfer of the values into the input of the shift registers of the 2^{nd} stage.

The outputs of all shift cells of the shift registers of the 2^{nd} stage with 256 shift cells are assigned to pixel electrodes, so that the values for all 32,768 pixels are available after (128*256)=32,768 clock cycles.

Now, a third clock cycle can trigger the transfer from the output to the pixel electrode. This requires an additional clock line and an additional transistor per electrode. Referring to FIG. 5, the other possibility is to connect the outputs of the shift register directly with the electrodes. In this case the background light must be dark while the information is written through the shift registers. This reduces the refresh rate, but allows a simpler structure to be used.

If three stages of shift registers are used with 32 shift cells each, the outputs of the 3^{rd} stage can also control 32,768 pixels after maximum 3*32=96 shifting operations (transfers).

The maximum possible number of transfers can thus be reduced drastically by employing a larger number of stages, so that shift registers with a very low CTE can be used too.

The maximum number of pixels which can be controlled by such a hierarchical structure is limited by the switching frequency (time needed for one transfer) of the shift register of the lowest stage which transports the information to the cluster. Since it is possible to use any number of stages for this global shift register, the switching frequency does not depend on the length of the conductors and thus on the display size, but only on the properties of the TFT substrate. At a switching frequency of for example 25 MHz, a shift register can control 32,768 pixels with a refresh rate of up to 763 Hz.

This is a major advantage of this implementation compared with conventional AM structures, because using better semiconductor materials which are expected for the near future and smaller transistors both the number of pixels and the refresh rate can be increased almost limitlessly and irrespective of the dimensions of the display device. In conventional displays with a conventional control of the AM, this is not possible because of the capacitance of the long row and column lines.

In addition to the implementation of the shift registers and further parts of the TFT display using the p-Si technology, as described above, these parts can alternatively be implemented using other semiconductor technologies, such as organic TFTs, poly-SiGe, mono-crystalline silicon or GaAs according to other embodiments. Poly-silicon (p-Si) here stands for the various possible sub-types, such as ULTPS, LPSOI, LTPS, HPS, CGS and others. The characteristics of the respective semiconductor technologies and their use with view to the requirements of this invention are apparent to a person skilled in the art and do therefore not require any further explanation here.

Moreover, any combination of the features and embodiments disclosed in this description and in the accompanying Figures which are considered to be part of the invention by a person skilled in the art shall be included in the scope of this invention even though they are not explicitly described in that particular combination.

1. Device for controlling the pixels of a pixel matrix, comprising:
A pixel matrix which is divided into a multitude of clusters,
At least one data driver circuit with at least one output for outputting control information per cluster, and
Global shift registers which are assigned to one or multiple clusters, said shift registers having an input for receiving the control information from the data driver circuit and for passing the received control information on to one or multiple clusters, where the global shift registers are disposed across the entire area of the pixel matrix between the pixels.

2. Device according to claim 1, wherein each cluster has a local digital and a local analogue shift register, both of which being arranged between the pixels of the pixel matrix, and where the control information is further distributed within the cluster with the help of an active matrix structure.

3. Device according to claim 2, wherein each pixel in the cluster can be controlled by a local row and column line, and where the assigned local analogue and local digital shift register is configured such to control the respective local row and column line of all pixels within the respective cluster in accordance with the received control information.

4. Device according to claim 1, wherein each cluster has an arbitrary number of hierarchically structured local analogue shift registers which branch off the global shift register and which serve to shift the control information in clock cycles.

5. Device according to claim 4, wherein the control information is transferred from the global shift register to the local analogue shift registers after N clock cycles, where the information is transported to the addressed pixel at a N-times slower clock cycle through an active matrix structure, and where N is the number of stages in the shift register.

6. Device according to claim 5, wherein synchronous clock pulses are provided through optical pulses which are converted into electric signals by multiple photosensitive receivers which are locally distributed across the pixel matrix.

7. Device according to claim 6, wherein the optical pulses are modulated into the light sources which serve for back-lighting the pixel matrix.

8. Device according to claim 1, wherein the clusters are divided into an arbitrary number of sub-clusters.

9. Device according to claim 1, wherein the pixel matrix is divided into square, rectangular or honeycomb-shaped clusters.

10. Device according to claim 1, wherein the pixel matrix uses TFTs to control the pixels, or wherein the pixel matrix uses a CCD structure to control the pixels.

11. (canceled)

12. Device according to claim 1, wherein the pixel matrix for controlling the pixels is a matrix of electrowetting cells.

13. Device according to claim 1, wherein the pixel matrix forms a display device for modulating the intensity and/or phase of light.

14. Device according to claim 13, wherein the pixel matrix is an OLED display, a MO display or an LC display.

15. Electronic display device which comprises a matrix of electrowetting cells as a pixel matrix according to claim 11, said matrix comprising a display device.

16. Optical element according to claim 11, wherein the pixel matrix forms an array of beam-deflecting and/or beam-shaping pixels.

17. Electronic display device which comprises a matrix of electrowetting cells as a pixel matrix according to claim 13, said matrix comprising a display device.

18. Optical element according to claim 13, wherein the pixel matrix forms an array of beam-deflecting and/or beam-shaping pixels.
